(19) United States
(12) Patent Application Publication
(10) Pub. No.: US 2012/0136934 A1
(43) Pub. Date: May 31, 2012

(54) DEVICE, SERVER, AND METHOD FOR SHARING DEEP LINKS OVER SOCIAL NETWORK

(75) Inventors: Abhishek Patil, San Diego, CA (US); Djung Nguyen, San Diego, CA (US); Dipendu Saha, San Diego, CA (US); Sriram Sampathkumaran, San Diego, CA (US)

(73) Assignee: SONY CORPORATION

(21) Appl. No.: 13/291,414

(22) Filed: Nov. 8, 2011

Related U.S. Application Data
(60) Provisional application No. 61/418,004, filed on Nov. 30, 2010.

(51) Int. Cl. G06F 15/16

(52) U.S. Cl. 709/204

(57) ABSTRACT

An audio video display device (AVDD) includes a display and a processor controlling the display to present an Internet-sourced program. Additionally, the processor causes the display to present a “share” selector element selectable by a user to cause a link associated with the program to automatically be sent to a friend device over a social networking site.

This application claims priority to U.S. provisional patent application Ser. No. 61/418,004, filed Nov. 30, 2010, incorporated herein by reference.

### FIELD OF THE INVENTION

The present application relates generally to content searching in Internet-enabled TVs.

### BACKGROUND OF THE INVENTION

Audio video (AV) devices such as TVs are growing increasingly capable, enabling viewers to watch videos from a wide range of sources with concomitant features. As understood herein, presenting additional information to viewers in an easy, intuitive, and non-cluttered way is desirable as more consumers desire increased access to audio video content without wanting to operate computers to obtain the information.

### SUMMARY OF THE INVENTION

Present principles recognize the desirability of an Internet TV which responds to content search queries and/or selection of links to audio video content by providing direct access to the content and not just to online services that host the content which, in turn, must be searched again by the user for the sought-after content. Furthermore, present principles recognize that friends who want to share direct links with each other in an Internet TV context should be provided with an easy and intuitive means to do so. Social networking sites, services, and applications can be used to this end.

Accordingly, an audio video display device (AVDD) includes a display and a processor. The processor controls the display to present an Internet-sourced program. The processor also causes the display to present a “share” selector element that is selectable by a user to cause a link associated with the program to automatically be sent to a friend device over a social networking site. In some implementations, the link includes a service identification identifying an Internet source of the program, an asset identification identifying the program, and/or a device identification identifying at least a type of the friend device. Also in some implementations, the device identification is used by a server identified by the service identification to optimally format a program identified by the asset identification according to the type of friend device.

Thus, in example embodiments, responsive to selection of the “share” selector element, the processor may automatically and without user input launch a social networking application and use the social networking application to send the link to the friend device. Also in example embodiments, the link sent to the friend device can link directly to the program's content and not just to a hosting service hosting the program, and then automatically begin streaming the content on the friend device when selected. If desired, selection of the link sent to the friend device may cause the friend device to automatically download a video service application to present the program using the video service application if the friend device does not already have the video service application.

As discussed at greater length below, in some implementations, the processor may also cause the display to present a list derived from or provided by the social networking site of friends having friend devices. The processor can thus send the link to one or more friend devices based on selection of one or more friends associated with the friend devices from the list. If desired, the list can include the first and last names of friends and the type of device associated with or used by the friend.

In another aspect, a server includes a processor and a computer readable storage medium accessible to the processor. The processor can receive, from a friend device, a selection of a link provided to the friend device over a social networking service. The processor can then obtain a type of device from the selection and obtain a program identification from the selection to format a program identified by the program identification according to the type of device. The processor then sends the program to the friend device to begin streaming thereon.

In still another aspect, a method includes presenting an audio visual program on an audio video display device (AVDD). The method further includes presenting a selector element on the AVDD selectable by a user of the AVDD to cause a link associated with the program to automatically be sent to a friend device.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is flow chart of overall example logic;

FIG. 3 is a screen shot of a search user interface (UI) with a results list that can be overlaid on the UI shown in phantom;

FIG. 4 is a screen shot of a guide UI presenting a content summary responsive to a link being selected from the results list;

FIGS. 5 and 6 are process flow diagrams illustrating details of an example specific embodiment;

FIG. 7 is a process flow diagram for streaming content received from an audio video content service on an AVDD in accordance with present principles;

FIG. 8 is an exemplary diagram of an interaction between a user of an AVDD sharing a direct link through a social networking service with another AVDD user;

FIG. 9 is a process flow diagram for viewing content associated with a direct link shared over a social networking service;

FIG. 10 a flow chart of exemplary logic for providing a direct link to underlying content to a friend over a social networking site in accordance with present principles;

FIG. 11 is a flow chart of exemplary logic for automatically streaming underlying content associated with a direct link sent by a friend and selected on a friend device;

FIG. 12 is an exemplary user interface (UI) presenting streaming content and a “share” selector element; and

FIG. 13 is a UI presenting a message sent through a social networking service to a friend device.

### DETAILED DESCRIPTION OF THE PREFERRED EMBODIMENT

Referring initially to FIG. 1, an audio video display device (AVDD) 12 in accordance with present principles, such as a TV, includes a housing 14 bearing a digital processor 16. The AVDD 12 alternatively may be a mobile telephone or personal digital assistant or digital clock radio or other device capable of presenting AV. The processor 16 can control a visual display 18 and an audible display 20 such as one or more speakers. The visual display may be a touch screen display or high definition TV display or other appropriate video display.

To undertake present principles, the processor 16 may access one or more computer readable storage media 22 such as but not limited to RAM-based storage (e.g., a chip implementing dynamic random access memory (DRAM)) and/or flash memory and/or disk-based storage. Software code implementing present logic executable by the AVDD 12 may be stored on one of the memories to undertake present principles.

If desired, in addition to the touch screen the processor 16 can receive user input signals from various input devices, including a keypad, a remote control device 26, a point and click device such as a mouse, etc. A TV tuner 28 may be provided in some implementations particularly when the CE device is embodied by a TV to receive TV signals from a source such as a set-top box, satellite receiver, cable head end, terrestrial TV signal antenna, etc. Signals from the tuner 28 are sent to the processor 16 for presentation on the display 18 and speakers 20.

As shown in FIG. 1, a network interface 30 such as a wired or wireless modem or wireless telephony transceiver communicates with the processor 16 to provide connectivity to one or more Internet servers, including a management server 32 with respective processors 32a and respective computer readable storage media 32b. The management server 32 may provide the AVDD 12 with selective access to AV content from one or more “searchable” asset servers 34 and one or more non-searchable asset servers 36. By “searchable” is meant an asset server which can receive queries from the AVDD 12 according to below principles and return direct links to conforming content without requiring the AVDD 12 to open a native search page of a service on the server, as opposed to asset servers 36 which support only searches launched from a native search page of the service hosted by the server. One or more AV input ports 38 can also be provided to receive television programming from respective sources including a disk player, a set top box, a cable head end, a satellite, a terrestrial broadcast antenna.

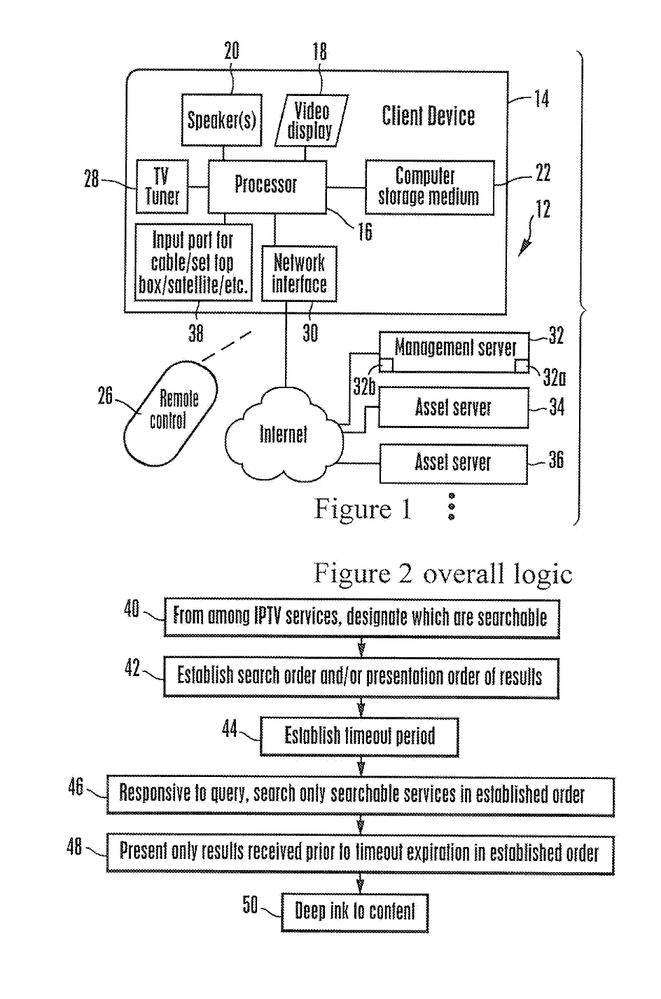

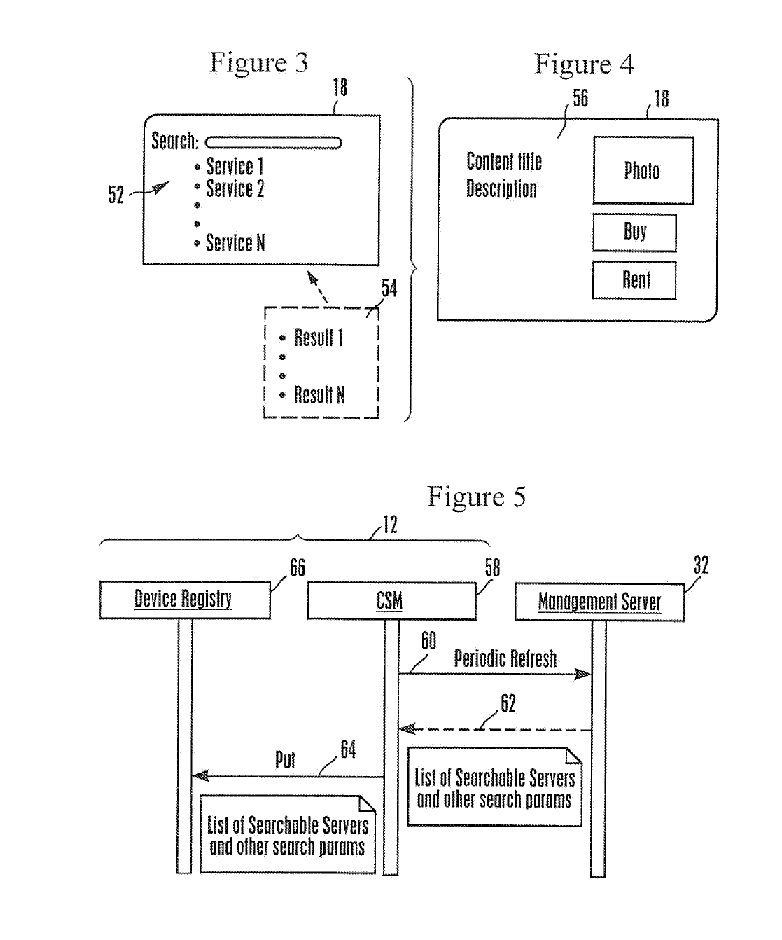

Now referring to FIG. 2, the manufacturer of the AVDD 12 configures the AVDD 12 to have “virtual channels”, i.e., content-providing websites of entities with whom the manufacturer has partnered according to various business arrangements. Each website provides a respective service and each website typically is hosted on one of the asset servers 34, 36 shown in FIG. 1. As set forth further below in reference to FIG. 3, the AVDD 12 presents links which may be represented by icons to the various services on the display 18 for selection by a viewer of the service to present content from the service on the display 18.

At block 40, from among the services, those that are “searchable” in accordance with principles herein directly from the AVDD 12 without having to employ the native search page of the service are designated “searchable”. It will be appreciated that a “searchable” service is affiliated with a searchable asset server 34. A “searchable” service typically agrees pursuant to a business arrangement with the manufacturer of the AVDD 12 to accept and employ an application programming interface (API) which accepts queries from AVDDs 12 and, without opening a native search page of the service, directly and transparently to the user searches for content of the service that satisfies the query and returns links thereto to the AVDD 12.

Block 42 indicates that a query order in which queries are sent to the searchable services (asset servers 34) may be established according to business needs. For example, service A may be established to be the first service to which a query is sent, followed by service B, and so on. Also or alternatively a response order in which query responses are presented on the display 18 can be established by service, so that, for instance, responses from service A are presented first on the display 18, then responses from service B second, and so on.

A timeout period may also be established at block 44. The timeout period may be fixed at some default period and if desired the viewer of the AVDD 12 may be permitted to change the period by means of a setup user interface (UI) presented on the display 18. Likewise, the user may be permitted to change the results order established at block 42.

Proceeding to block 46, responsive to a query input using, e.g., the example search UI of FIG. 3 discussed further below, the processor 16 sends the query only to those asset servers (hosting respective services) affiliated with virtual channels that have been designated as “searchable” at block 40. The queries are sent to the searchable services in the query order established at block 42.

Moving to block 48, results which are received prior to expiration of the timeout period established at block 44 are presented on the display 18 in the response order established at block 42, in the form of links to the underlying content. Results received after expiration of the timeout period are discarded and not displayed. The importance of the query order may now be appreciated, because those services that are earlier in the query order have more time to respond prior to timeout expiration than those that are later in the query order.

Block 50 indicates that responsive to a viewer selecting one of the links in the displayed results, the viewer is linked directly to a guide UI dedicated to the content associated with the link in accordance with further discussion below.

FIG. 3 illustrates an example search UI 52 that may be presented on the display 18. As shown, the search UI 52 lists multiple services that are available online and that can provide AV content to the AVDD 12 when a service is selected. The search UI may also include a search input element as shown into which a viewer may type a query.

As discussed above the query is sent to the searchable services only, in some examples in a predetermined query order, and responses returned, if desired in a predetermined response order, and such responses are shown in the UI 54 of FIG. 3 (showing results 1-N). In an example implementation, the response UI 54 is overlaid onto the search UI 52 and the search UI grayed or lowlighted.

As also discussed above, a viewer can click on one of the responses, which links the viewer directly to the underlying content on the associated searchable asset server 34. In non-limiting examples, the asset server 34 executing the above-described returns a guide UI 56 shown in FIG. 4 that pertains to the underlying content of the selected link. The example guide UI shown includes a photograph related to the content, the content title, a text description of the content, and “buy” and “rent” selector elements which may be selected by a viewer to buy or rent, respectively, the content in the event that the content is pay content. In other implementations no guide UI need be provided; rather, in response to selection of a link from the results UI 54 the processor 16 may immediately start streaming the associated content from the associated asset server 34, presenting the content on the display 18 and/or speakers 20.

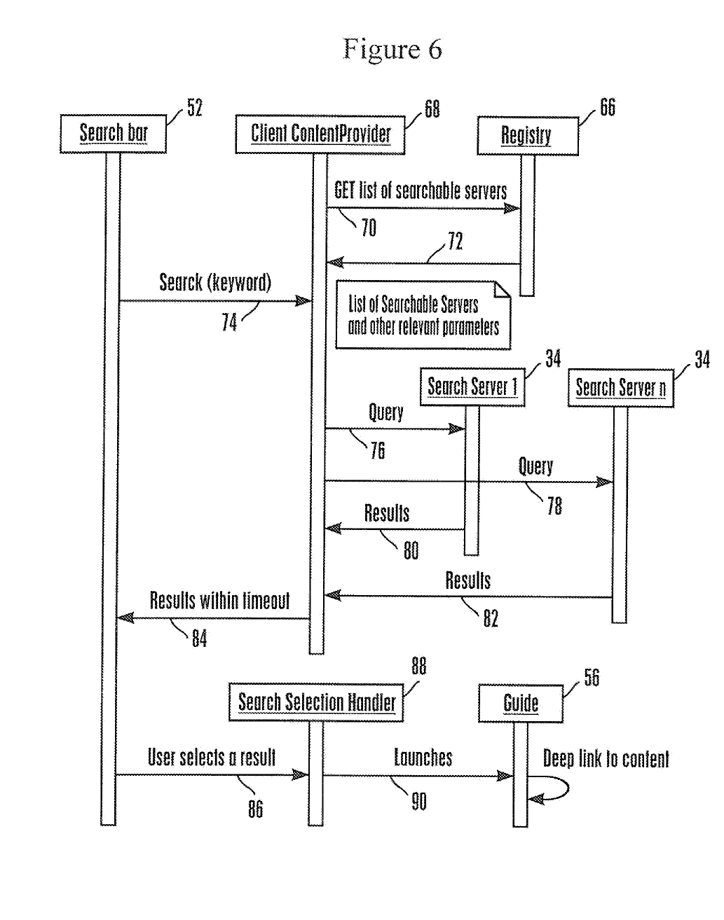

FIGS. 5 and 6 show implementation details of an example embodiment. A content service manager (CSM) module 58 (FIG. 5) that may be stored on the medium 22 and executed by the processor 16 sends, at 60, a periodic refresh request to the management server 32. At 62 a list of available services is returned, including designations of which ones are searchable in accordance with principles above. At 64 the CSM module 58 provides the list to a device registry 66 that also may be stored on the medium 22 and executed or accessed by the processor 16.

Moving to FIG. 6, a client content provider (CCP) module 68 that may be stored on the medium 22 and executed by the processor 16 sends a GET message to the registry 66 at 70 and obtains the list at 72. The registry 66 may return a list of all available services, searchable or not, and designate those that are searchable using, e.g., a flag, so that the searchable services subsequently may be identified and the non-searchable services not presented with the query. Or, the registry 66 may weed out the non-searchable services and return at 72 only the searchable services to the CCP module 68.

In any case, a search from the viewer inputting a query term to the search bar of the search UI 52 of FIG. 3 may be received at 74 by the CCP module 68. In response, the CCP module 68 sends, at 76, the query to a first searchable service server 34 and at 78 to a second searchable server 34, and so on in the query order established above, until all searchable services identified in FIG. 2 and only the searchable services have been sent the query. Results from the respective servers are returned at 80/82 and those results and only those results received prior to expiration of the timeout period are presented on the display 18 (e.g., in the form of the results UI 54 of FIG. 3) at 84. At 86, a viewer may click on a link on the results UI 54 which is sent to a search selection handler (SSH) 88 module executed by the processor 16. The SSH module 88 launches, at 90, the guide UI shown in FIG. 4 or begins streaming the content itself by deep-linking to the associated content in the associated asset server 34 as described above.

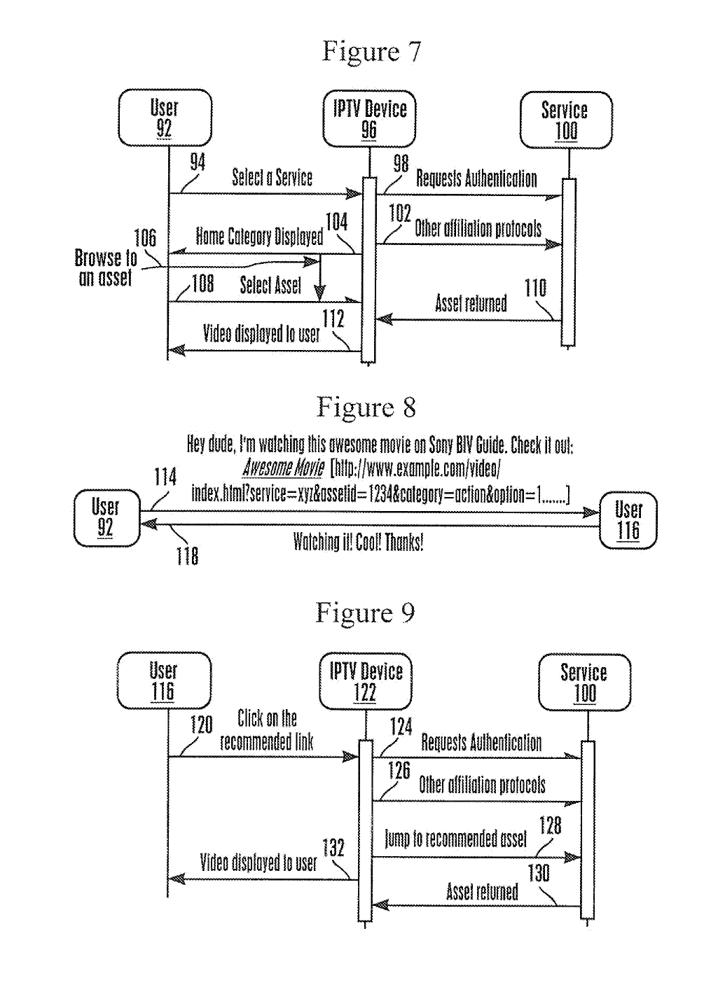

Now in reference to FIG. 7, a process flow diagram for presenting and/or streaming content received from an audio video content provider and/or audio video content service on an AVDD in accordance with present principles is shown. Thus, at 94, a user 92 selects a content provider and/or content service through an IPTV device 96, which is understood to be an AVDD associated with user 92, to view content such as an audio video program. In example embodiments, the content service may be the Sony Bravia Internet Video (Sony BIV) service or any other Internet video service.

However, it is to be understood that while present principles apply to Internet video services such as Sony's BIV service and others described above (e.g., the “searchable service,” an online service hosting content, or a content-providing website), the terms “content provider” and “content service” as used herein are not restricted only to Internet video services, but may also include video services accessed through, e.g., other types of wide area networks, closed-area networks, local area networks, home networks, campus area networks, metropolitan area networks, etc. Additionally, note that while IPTV devices are sometimes disclosed in reference to FIGS. 7-13, it is to be understood that any AVDD may be used in accordance with some embodiments. Therefore, for example, smartphones and tablet computers may be used in place of the IPTVs disclosed herein.

Regardless, after a service is selected at 94 of FIG. 7, the IPTV device 96 requests authentication from the content provider/service 100 (hereafter referenced simply as the “service 100” for convenience) at 98. At 102 other affiliation protocols are provided by the IPTV device 96 to the service 100. However, it is to be understood that exchange of authentication information, other affiliation protocols, and other data/information may be bidirectional in accordance with principles known in the art, even though not explicitly shown in FIG. 7.

Nonetheless, at 104 the IPTV device 96 displays, e.g., a “home content category” in a guide as shown, which in example embodiments may be deemed a “home” page, “home” guide, “home” category screen, “welcome” page, “home” screen interface, etc., or any other non-limiting interface initially presented after authentication that may be manipulated to access content through the service 100. Note that the “home content category” presented in a guide as referenced immediately above is not the same “guide UI” described in reference to FIG. 4 that provides a content summary of a specific asset. Thus, so as to not confuse the two, the example “home content category” presented in a guide as understood in reference to FIG. 7 will be referred to as a “home UI.” Furthermore, it is to be understood that the non-limiting home UI referenced in FIG. 7 is only presented at 104 if service 100 has allowed the IPTV device 96 access to its content after authentication has been established and exchange of any necessary affiliation protocols or other login information between the IPTV device 96 and service 100 has been completed.

Accordingly, once the home UI is presented on the IPTV 96 to user 92 at 104, user 92 may browse to an asset at 106 using the home UI or any subsequent UI presented on the IPTV device 96. However, note that in some embodiments the user 92 may instead query the service 100 in accordance with the principles set forth above. Also note that the term “asset” as used herein is a term that can refer to data and/or content in many different formats.

Regardless, at 108 the user 92 selects an asset from the service 100 and at 110 the asset is returned from the service 100 to the IPTV device 96 for presentation thereon. Hence, the asset returned at 110 is presented to the user 92 at 112. Note further that at 112 a “share” selector element may also be presented on the screen of the IPTV device 96 along with the asset so that user 92 may share a direct link associated with the asset with a friend over, e.g., a social networking site in accordance with principles set forth below.

Thus, reference is now made to FIG. 8, which shows an exemplary diagram of an interaction between a user of an AVDD sharing a direct link through a social networking service with another AVDD user. As may be appreciate from FIG. 8, user 92 shares a direct link to a movie at 114 accessed through the service 100. In addition to the direct link, a message (e.g., “Hey dude, I'm watching this awesome movie . . . ”) may be shared at 114 indicating that a friend of user 92, generally designated as user 116 and associated with a friend device, should view the movie. It is to be understood that in the exemplary embodiment shown, the link shared by user 92 is a direct link that may be selected to automatically begin streaming content in accordance with present principles. However, it is to be further understood that in other embodiments the direct link provided may instead link to a guide UI such as the guide UI of FIG. 4 for presenting a content summary if, e.g., the content being linked to must be rented or purchased prior to being streamed on the AVDD associated with user 116.

Furthermore, note that the direct link shown in FIG. 8 includes parameters described herein such as a service ID and asset ID. Further still, it may be appreciated from FIG. 8 that the link shared at 114 may include hypertext and/or include text containing the actual address associated with the link. Thus, as indicated above, it is to be understood that the message and link may be sent through one or more social networking sites, services, and/or applications in accordance with present principles after user 92 has selected a non-limiting “share” selector element as described above. Completing the description of the exemplary diagram shown in FIG. 8, at 118 a message is sent from user 116 to user 92 indicating receipt of the direct link and thanking user 92 for sharing the direct link with user 116.

Moving on to FIG. 9, a process flow diagram for viewing content associated with a direct link shared over a social networking service is shown. However, note that while one or more social networking sites, services, and/or applications may be used to share a link in accordance with present principles, it is to be understood that in other embodiments a link may be shared through other electronic communication means, such as, e.g., email, text messaging, real-time chat, etc. Regardless, it may be appreciated from FIG. 9 that user 116 has received a direct link recommended or shared by user 92 as described above. At 120 the direct link is selected by user 116 for viewing the underlying content associated with the link on an IPTV device 122, it being understood that the IPTV device 122 is an AVDD and/or friend device associated with user 116.

Thus, at 124 the IPTV device 122 requests authentication from the service 100. At 126 other affiliation protocols are provided by the IPTV device 122 to the service 100. However, it is to be understood that exchange of authentication information, other affiliation protocols, and other data/information may be bidirectional as indicated above. It is to be further understood that after authentication has been established and affiliation protocols have been exchanged, the service 100 may grant the IPTV device 122 access to content such as the underlying content associated with the link sent by user 92. Moving on, at 128 the IPTV device 122 automatically “jumps” and/or requests the specific asset associated with the link shared by user 92 as indicated above rather than, e.g., causing a home UI or navigation screen to be presented on the IPTV device 122 that would otherwise require user 116 to navigate to the content. Then at 130 the service 100 returns the asset associated with the link shared by user 92 and at 132 the asset (in this case, a video/movie) is presented on the IPTV device 122.

It may therefore be appreciated that users of AVDDs can share direct links to content such that the underlying content automatically streams on the IPTV device 112 when the link is selected in accordance with the deep-linking principles set forth above. Alternatively, note that selection of the direct link may take a user to a guide UI as set forth above (if, for example, the content must be purchased prior to viewing) without opening a native search page of the service.

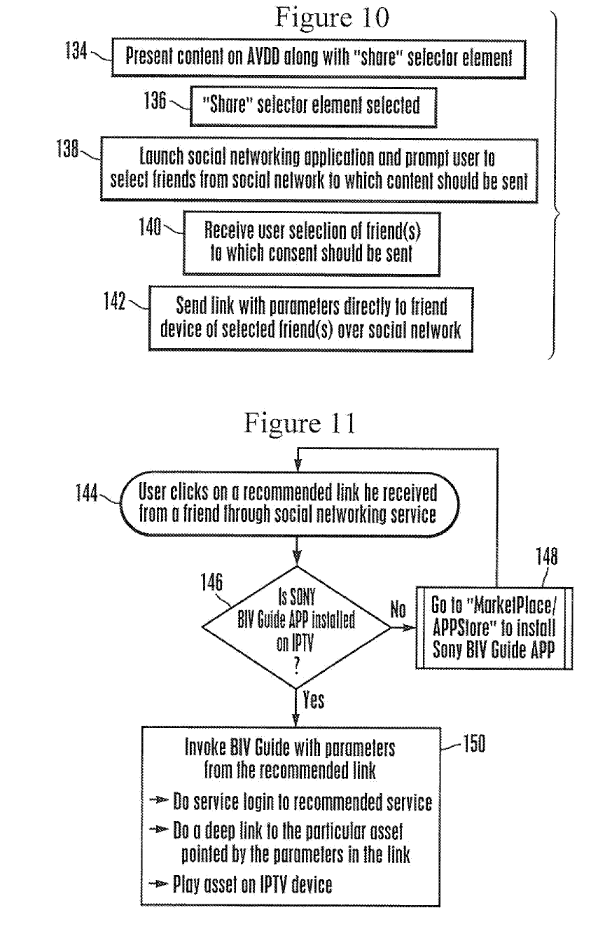

Continuing the present detailed description, reference is now made to FIG. 10. FIG. 10 is a flow chart of exemplary logic for providing a direct link to underlying content to a friend over a social networking site in accordance with present principles. Thus, it is to be understood that the logic described in reference to FIG. 10 may be executed by a processor on an AVDD, such as the processor 16 described above. Beginning at block 134, the logic presents content on the AVDD along with a “share” selector element, it being understood that the content may be streamed from a content provider, content service, internet video service or the like in accordance with present principles. At block 136, the logic receives a user's selection of the “share” selector element to share the currently streamed content with a friend.

The logic then moves to block 138 where the logic automatically and without user input launches a social networking service and/or application associated with the user. Still at block 138, the logic then prompts the user to select one or more friends having friend devices from a list of friends to which the user desires to send a direct link to the currently streaming content. It is to be understood that the list is derived from or provided by one or more social networking services. The list may include the first and last names of friends associated with the user through the social networking service, and the type of friend device associated with the friend.

It is also to be understood that a “friend device” may be an AVDD such as, but not limited to, a tablet computer, smartphone, laptop computer, IPTV, etc. with which a friend of the user (e.g., a social networking friend, an old high school or college friend, a family member, etc.) is associated and which the friend is able to view and/or stream underlying content associated with the direct link sent by the user. Note that in some embodiments the list of friends having friend devices may be provided by the social networking service itself. In other embodiments the list may be derived from data from the social networking service by, e.g., the user's AVDD, a remote server, or a third party application.

Continuing in reference to FIG. 10, at block 140 the logic receives the user's selection of one or more friends from the list to which a direct link to the underlying streaming content should be sent. Then at block 142 a direct link to the underlying content including parameters to be discussed further below is sent to the friend(s) specified by the user through the social networking service.

Now in reference to FIG. 11, a flow chart of exemplary logic for automatically streaming underlying content associated with a direct link sent by a friend and selected on a friend device is shown. Similar to FIG. 10, it is to also be understood in relation to FIG. 11 that the logic described below may be executed by a processor on the friend device.

Beginning at oval 144, a user selects a direct link shared by a friend. Note that the direct link selected at oval 144 of the exemplary logic has been received at the friend device through a social networking service, site, or application that was already accessed or launched on the friend device, or that was caused to be accessed or launched on the friend device. In accordance with present principles, the social networking service or application could be launched or accessed by, e.g., a remote server relaying the message containing the direct link to the friend device. In other embodiments, the social networking service or application could be launched or accessed by the friend device itself if a notification was received at the friend device of an incoming or sent social networking message, though it is to be further understood that the social networking service or application may be launched or accessed through other means. Furthermore, note that in alternate embodiments the message and direct link may be sent through still other communication means such as email or text messaging.

Continuing in reference to FIG. 11, the logic moves to decision diamond 146 where the logic determines whether any video service application is present and/or installed on the friend device. In some circumstances, the video service application may be associated with a content provider and/or content service that should be used, or is preferred to be used, to present the underlying content associated with the direct link selected at oval 144. As shown at diamond 146, for example, the logic may determine whether Sony's BIV application is installed on the friend device.

If the logic determines at diamond 146 that a video service application that may be used to present the direct link's underlying content is not installed on the friend device, the logic continues to block 148 where logic causes the friend device to automatically download and install the appropriate video service application. In exemplary embodiments, the video service application may be downloaded from an application provider such as Google's Droid Marketplace or Apple's App Store, or still other application providers suitable for providing the video service application determined at diamond 146. Nonetheless, after the video service application is downloaded and installed on the friend device at block 148, the logic reverts to oval 144 and the logic may proceed from there.

Again in reference to decision diamond 146, if the logic determines that the appropriate video service application is in fact already installed on the friend device, the logic instead moves to block 150 rather than to block 148. At block 150 the video service application, such as Sony's BIV application, is used to present and/or stream the underlying asset associated with the direct link. Additionally, note that in some embodiments the friend device may have to login to the video service associated with the application.

Still in reference to FIG. 11, block 150 discloses parameters in the direct link. The parameters contained in the direct link may be used to begin automatically streaming the associated content by deep-linking to the content in accordance with present principles. The parameters in the shared link may include a service identification identifying an Internet source of the content and/or program, an asset identification identifying the content and/or program, and a device identification identifying at least a type of the friend device executing the logic of FIG. 11. Furthermore, it is to be understood that in some embodiments the device identification is used by a server identified by the service identification (and hence associated with the video service) to optimally format content identified by the asset identification according to the type of friend device. Thus, content may be formatted differently to achieve different optimum formats for presentation on different types of AVDDs. E.g., content may be formatted differently for presentation on a smartphone as opposed to presentation an IPTV or tablet computer. Also note that the device ID itself can be provided as part of the data included on the list of friends described herein or automatically determined from the friend device over the social networking service so that it may be, e.g., added or embedded into the link. Regardless, after the content is optimally formatted based on the type of friend device, the logic presents the content on the friend device at block 150.

While the logic of FIG. 11 has been described as being executed by a processor on the friend device receiving the shared link, it is to be understood that the logic may be implemented by a server such as an Internet server and/or one of the servers described above having at least a processor, storage medium and network interface. The server's processor may therefore remotely execute some or all of the above steps on the friend device. For example, after a user of the friend device selects the direct link, a server associated with a video service may receive notification from the friend device of the selection, obtain the friend device's device type, obtain a content and/or program identification from the selection, format the content and/or program identified by the content and/or program identification according to the type of device, and then send the program to the friend device for presentation thereon. If desired, the content and/or program sent from the server to the friend device may be sent over the Internet or any other suitable means.

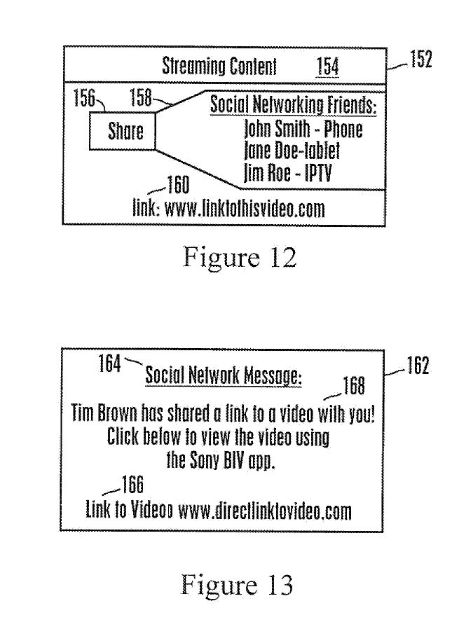

Now in reference to FIG. 12, an exemplary user interface (UI) presenting streaming content and a “share” selector element in accordance with present principles is shown. FIG. 12 thus shows a UI generally designated 152 that includes a section 154 streaming content. The UI 152 also has a “share” selector element 156 in a separate part of the UI 152, although it is to be understood that in other embodiments the selector element 156 may be superimposed onto the section 154 streaming content if, for example, the content is streaming in full screen mode such that the streaming content is presented on the entire display of the AVDD.

Regardless, the UI 152 also includes a list 158 of friends from one or more social networking service associated with the user of the AVDD presenting the UI 152. It may be appreciated from the list 158 shown in FIG. 12 that it includes the first and last names of the user's friends, and also the type of friend device with which the friend is associated. It is to be understood that while the UI 152 presents the list 158 as shown in FIG. 12, in some embodiments the list 158 may not be presented until the user selects the “share” selector element, at which point the list 158 may be presented as, e.g., a pop-up list or otherwise dynamically changing or refreshing the UI 152. Regardless, the friends represented on the list 158 are understood to be selectable in order to share direct links with the friends accordance with present principles.

In addition, the UI 152 may include an Internet link 160 associated with the streaming content, if desired. Note that the link 160 may include hypertext and/or include text containing the actual address associated with the link. However, it is to be understood that the link 160 may be the same or different than the direct link sent by the user to a friend through a social networking service in accordance with present principles. For example, the link 160 may simply be an Internet link to the content, while a direct link associated with the underlying content and sent to a friend device may be different than an Internet link not containing parameters such as the ones described above.

Concluding the present detailed description in reference to FIG. 13, a UI presenting a message sent through a social networking service to a friend device in accordance with present principles is shown. It is to be understood that the exemplary UI shown in FIG. 13 may be presented after launch of a social networking service in accordance with the principles set forth above.

Thus, a UI generally designated 162 is shown in FIG. 13 and may include an indicator 164 notifying the friend using the friend device that message has been received though the friend's social network. An exemplary message 168 is also shown on the UI 162 and indicates that a person associated with the friend through the social networking service has shared a link to a video with the friend. As may be appreciated from FIG. 13, the message 168 indicates how the friend may view the underlying video on the friend device. In the present example, the friend may click or otherwise select a direct link 166 presented below the message 168, which will then cause the underlying video to automatically begin streaming on the friend device through, e.g., a video service application. Therefore, it may be appreciated that the friend device, or alternatively a server hosting the social networking service and/or the underlying content, may cause the video service application to launch on the friend device once the link 166 has been selected, and subsequently present the underlying content.

While the particular DEVICE, SERVER, AND METHOD FOR SHARING DEEP LINKS OVER SOCIAL NETWORK is herein shown and described in detail, it is to be understood that the subject matter which is encompassed by the present invention is limited only by the claims.

What is claimed is:

1. An audio video display device (AVDD) comprising:
a display;
a processor controlling the display to present an Internet-sourced program, the processor causing the display to present a “share” selector element selectable by a user to cause a link associated with the program to automatically be sent to a friend device over a social networking site.

2. The AVDD of claim 1, wherein the link includes a service identification identifying an Internet source of the program.

3. The AVDD of claim 2, wherein the link includes an asset identification identifying the program.

4. The AVDD of claim 3, wherein the link includes a device identification identifying at least a type of the friend device.

5. The AVDD of claim 1, wherein responsive to selection of the “share” selector element, the processor automatically and without user input launches a social networking application, the processor using the social networking application to send the link to the friend device.

6. The AVDD of claim 4, wherein the device identification is used by a server identified by the service identification to format a program identified by the asset identification as appropriate for the type of friend device.

7. The AVDD of claim 1, wherein the link sent to the friend device links directly to the program's content and not just to a hosting service hosting the program and automatically begins streaming the content on the friend device when selected.

8. The AVDD of claim 1, wherein selection of the link sent to the friend device causes the friend device to automatically download a video service application to present the program using the video service application if the friend device does not already have the video service application.

9. The AVDD of claim 1, wherein the processor causes the display to present a list derived from or provided by the social networking site of friends having friend devices, wherein the processor sends the link to one or more friend devices based on selection of one or more friends associated with the friend devices from the list.

10. The AVDD of claim 9, wherein the list includes the first and last names of friends and the type of device associated with the friend.

11. A server, comprising:
a processor;
a computer readable storage medium accessible to the processor to:
receive from a friend device a selection of a link provided to the friend device over a social networking service;
obtain a type of device from the selection;
obtain a program identification from the selection;
format a program identified by the program identification according to the type of device; and
send the program to the friend device.

12. The server of claim 11, wherein the server launches the social networking service on the friend device to provide the link to the friend device.

13. The server of claim 11, wherein the server causes the program to be automatically presented on the friend device after sending the program to the friend device.

14. The server of claim 13, wherein the server causes the program sent to the friend device to be presented on the friend device using a video service application.

15. The server of claim 14, wherein the server causes the friend device to automatically download the video service application to present the program if the friend device does not already have the application.

16. A method, comprising:
presenting an audio visual program on an audio video display device (AVDD); and
presenting a selector element on the AVDD selectable by a user of the AVDD to cause a link associated with the program to automatically be sent to a friend device.

17. The method of claim 16, wherein responsive to selection of the selector element, the method further includes automatically and without user input launching a social networking application and using the social networking application to send the link to the friend device.

18. The method of claim 16, further including presenting a list of friends associated with respective friend devices on the AVDD, wherein the list is derived from or provided by a social networking service, and sending the link over the social networking service to one or more respective friend devices based on selection of one or more friends associated with friend devices from the list.

19. The method of claim 16, further including causing the friend device to automatically present the program using a video service application when the link is selected at the friend device.

20. The method of claim 19, further including causing the friend device to automatically download the video service application to present the program when the link is selected if the friend device does not already have the video service application.
